(19) United States
(12) Patent Application Publication
(10) Pub. No.: US 2011/0079976 A1
(43) Pub. Date: Apr. 7, 2011

(54) Skateboard with enclosed chassis and improved suspension

(75) Inventor: Jared Siegwarth Seip, Washington, DC (US)

(73) Assignees: Jared Siegwarth Seip, Washington, DC (US); Seip Aerospace LLC, Washington, DC (US)

(21) Appl. No.: 12/574,615

(22) Filed: Oct. 6, 2009

(51) Int. Cl. B62M 1/00

(52) U.S. Cl. 280/87.042

(57) ABSTRACT

A skateboard with an internal chassis and external shell allows for the enclosure of internal components within a contoured body. The skateboard makes use of a plurality of shock absorbers and swing-arms to provide superior riding characteristics on rough terrain.

### BACKGROUND OF THE INVENTION

Skateboards, roller skates, and in-line skates belong to a family of products used for recreation and personal transport. The continued growth and popularity of this market segment has resulted in attempts to improve and upgrade these products with novel drive, suspension and braking systems. One such novel upgrade, issued to Hsu et al. in U.S. Pat. No. 5,330,026 sets forth a REMOTE CONTROL ELECTRIC SKATEBOARD having a motor governed “by a remote controller transmitting a signal to an electronic circuit carried on the board.”

U.S. Pat. No. 5,803,468 issued to Petrucci et al. sets forth a BRAKE AND REMOTE CONTROL SYSTEM FOR WHEELED SKATE “having a fluid pressure brake which is fully remotely controlled via a radio frequency transmitter.”

U.S. Pat. No. 6,315,630 issued to Yamasaki sets forth a REMOTELY CONTROLLED SKATEBOARD HAVING MOTION-RESPONSIVE DOLL RIDING THEREON wherein “a skateboard and remote control unit cooperate to provide remotely controlled movement of a skateboard in response to user commands.”

U.S. Pat. No. 7,581,739 issued to Fraley sets forth a SKATEBOARD DECK AND SPRING BASED TRUCK wherein springs are integrated into the truck such that the “spring based trucks and synthetic deck enhance the flex and feedback of the board, to provide the user with maximum snap.”

U.S. Pat. No. 6,318,739 issued to Fehn et al. sets forth a SUSPENSION FOR A SKATEBOARD wherein “a shock absorber is located between the base plate and the truck plate.”

While the foregoing described prior art devices have to some extent improved the art and in some instances enjoyed commercial success, contemporary in-line skates, skateboards, and roller skates still suffer from two primary afflictions. First, they perform poorly on rough and uneven surfaces because they lack a well-conceived suspension. Second, improvements to skateboards and skates (such as motors, brakes, and suspensions) are typically attached to the outside of said prior art devices, rather than housed internally, thus resulting in a bulky, non-aerodynamic shape.

### SUMMARY OF INVENTION

The present invention is an internal chassis, external enclosure, and improved suspension for a skateboard. It is the general object of the present invention to provide better handling and performance to skateboard users. It is a more specific object of the invention to provide a smoother ride on rough surfaces. It is a yet more specific object of the invention to provide predictable, progressive, and fluid turning. Still, it is an even more specific object of the invention to minimize the changes in skateboard trajectory that might result from unevenness in riding surfaces.

### BRIEF DESCRIPTION OF THE DRAWINGS

The features of the present invention, which are believed to be novel, are set forth in the attached drawings. Each figure contains two drawings, one showing the outer shell of the skateboard, the other showing the internal chassis and suspension. Herein,

FIG. 1 sets forth a head-on view of the present invention;

FIG. 2 sets forth an isometric view of the present invention;

FIG. 3 sets forth top-down view of the present invention;

FIG. 4 sets forth a side view of the present invention.

### DESCRIPTION OF THE PREFERRED EMBODIMENT

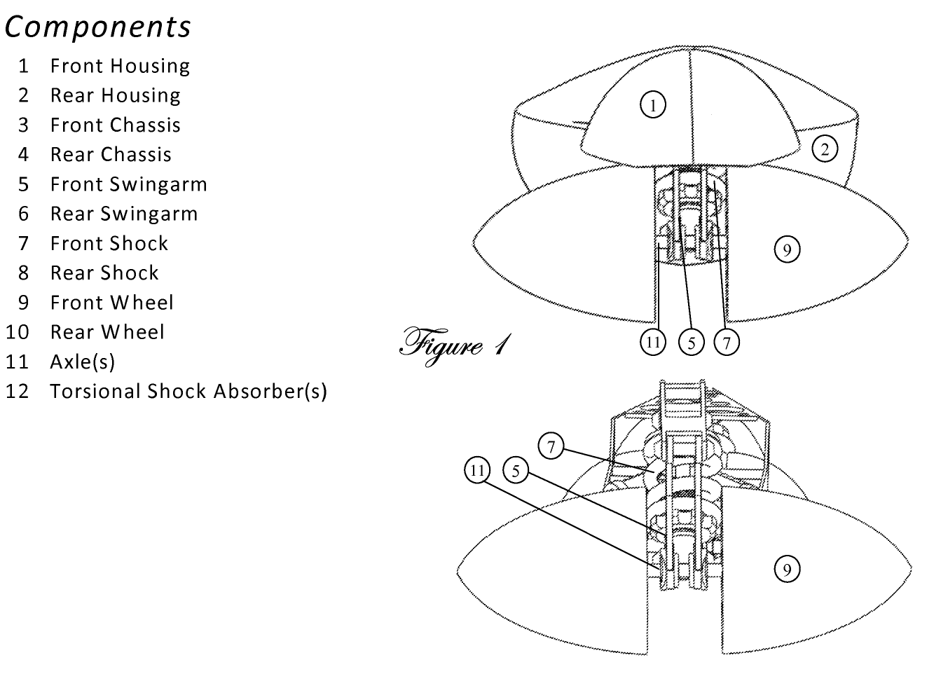

FIG. 1 sets forth a head-on view of the present invention looking from front to back down the length of the board. The skateboard is enclosed by front and rear housings 1 and 2 wherein each housing has both an upper and lower surface wherein the upper surface of housing 2 constitutes the surface upon which the rider stands. The lower surfaces of housings 1 and 2 are each fitted with a concavity which accommodates the curvature of wheels 9 and 10 respectively.

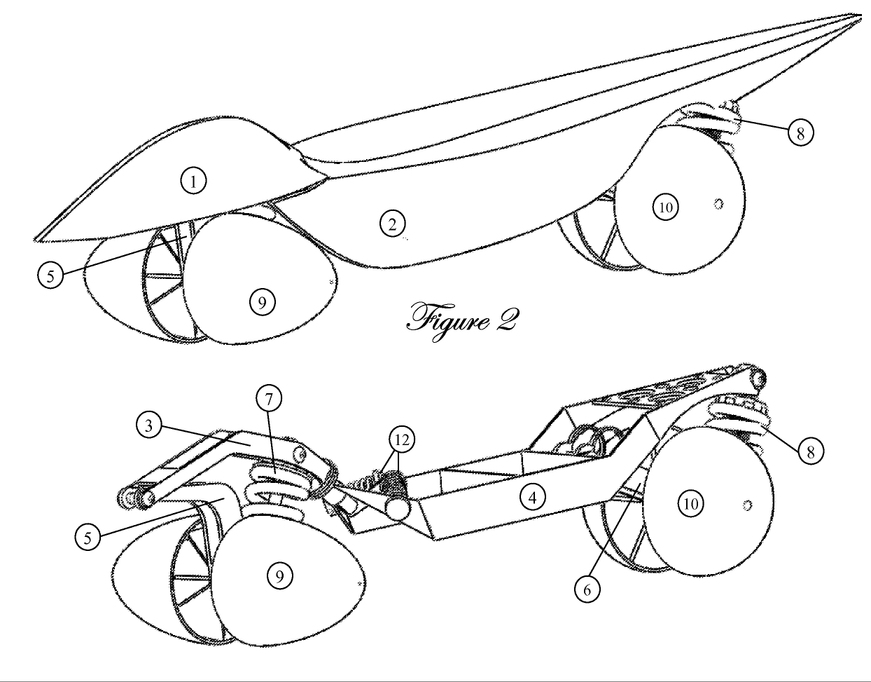

FIG. 2 sets forth an isometric view of the present invention further clarifying the relationship between above-mentioned components 1, 2, 9 and 10. Furthermore, FIG. 2 illustrates the relationship between front and rear chassis 3 and 4 wherein front and rear chassis 3 and 4 fits together through a concentric “kingpin” mate immediately behind front shock absorber 7. Said mate allows front and rear chassis 3 and 4 to move independently of each-other on a fixed plane perpendicular to the kingpin. Movement on this plane is mediated through torsional shock-absorbers 12 when the rider shifts his weight to either side of the riding surface.

Additionally, FIG. 2 illustrates the geometric and mechanical relationships between front and rear chassis 3 and 4 and front and rear suspension systems comprised of front and rear shock absorbers 7 and 8 and front and rear swingarms 5 and 6. Said components are attached to one another by use of a plurality of screw pins (not labeled) such that movement of both front and rear suspension systems are isolated to a fixed plane. Shock absorbers 7 and 8 are angled toward the direction of travel such that wheels 9 and 10 move away from the direction of travel as they encounter large shocks, bumps, or road debris.

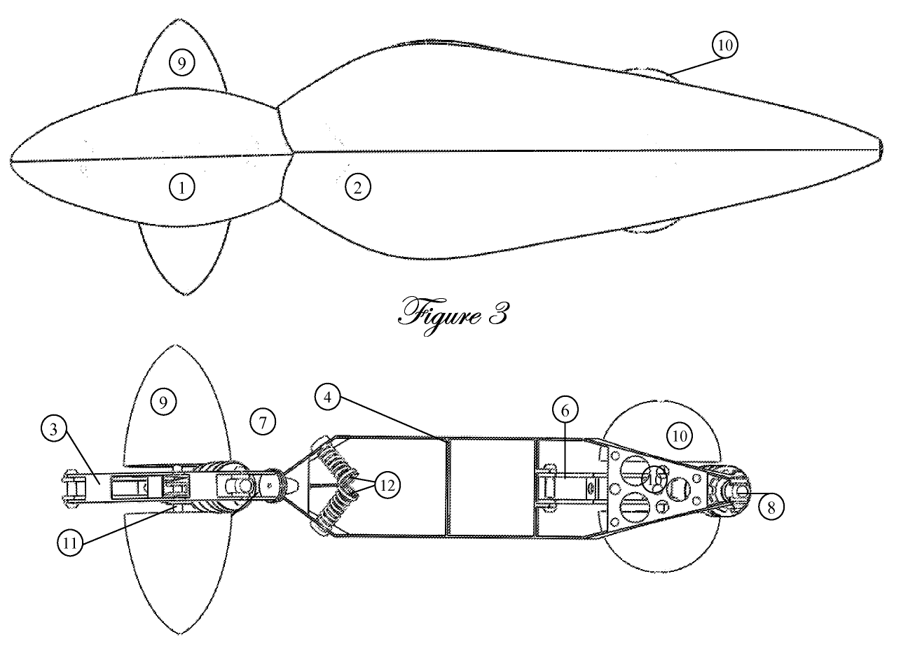

FIG. 3 sets forth a top-down view of the present invention wherein the top of rear housing 2 constitutes a near-flat riding surface. FIG. 3 further clarifies the geometry and arrangement of front and rear chassis 3 and 4 and front and rear swingarm 5 and 6 wherein all components are centered on and parallel to a centerline running the length of the skateboard. Axles 11 are mounted perpendicular to this centerline and are mounted at the center of front and rear wheels 9 and 10.

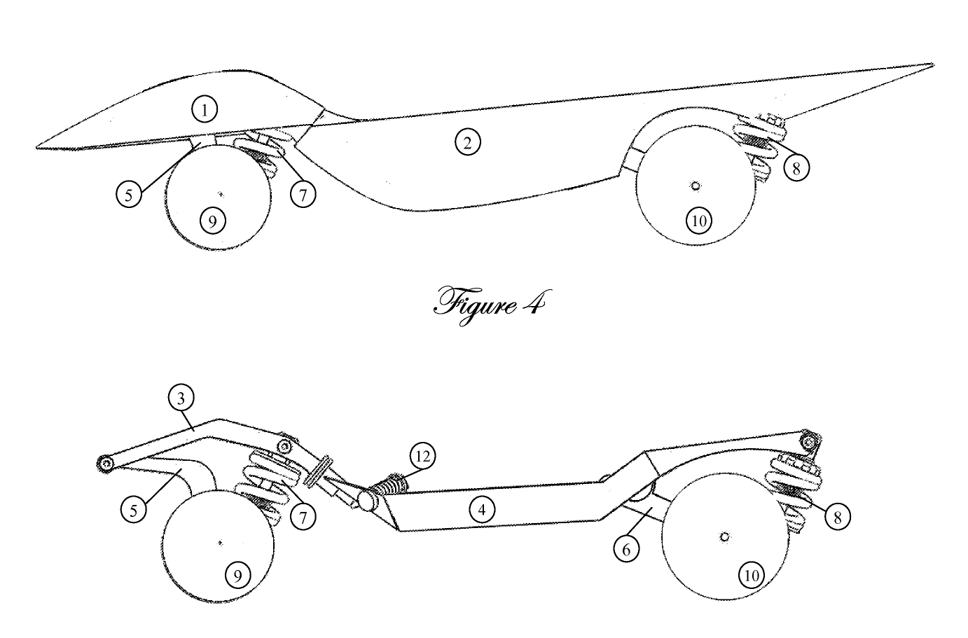

FIG. 4 sets forth a side view of the present invention wherein the horizontal profile of front and rear housings 1 and 2 as well as front and rear chassis 3 and 4 can be seen more clearly.

I claim:

1. A skateboard with an internal chassis and external shell, to include:
a load-bearing multi-piece chassis;
an external enclosure contouring around said chassis.

2. An improved skateboard suspension system, wherein the improvement comprises:
a suspension system linking one or more wheels to said chassis via a coupling of shock absorbers and swing-arms;
a dampened, torsion-based steering system mounted apart from said suspension system, such that said steering system is isolated from undampened wheel feedback.
